(19) United States
(12) Patent Application Publication
(10) Pub. No.: US 2004/0082207 A1
(43) Pub. Date: Apr. 29, 2004

(54) Anisotropic conductive elastic connector

(75) Inventors: Masakazu Koizumi, Nishikamo-gun (JP); Takeshi Watanabe, Nishikamo-gun (JP)

Correspondence Address: MERCHANT & GOULD PC, P.O. BOX 2903, MINNEAPOLIS, MN, 55402-0903, US

(73) Assignee: FUJI POLYMER INDUSTRIES CO., LTD., Nagoya-shi (JP)

(21) Appl. No.: 10/663,223

(22) Filed: Sep. 15, 2003

(30) Foreign Application Priority Data
Oct. 24, 2002 (JP) 2002-310171

(51) Int. Cl. H01R 4/58

(52) U.S. Cl. 439/91

(57) ABSTRACT

An anisotropic conductive elastic connector of the present invention includes plural linear conductors arranged in the thickness direction of an insulation elastic resin material. On the side face of the linear conductor, an electric insulation coating having a withstand voltage of 1 V/μm or more is formed in a thickness of 1 μm or more. The linear conductors are arranged with a pitch interval of 0.01 mm or less or are adjacent to each other in the direction of the arrangement. Thus, an anisotropic conductive elastic connector, which does not cause a short even if metal fibers are arranged with high density, is provided.

### BACKGROUND OF THE INVENTION

1. Field of the Invention

The present invention relates to a pressure welding type anisotropic conductive elastic connector used, for example, for connecting between electric/electronic components and a circuit board.

2. Related Background Art

As a conventional pressure welding type anisotropic conductive elastic connector, a laminated type rubber connector is proposed (see U.S. Pat. No. 3,680,037). The laminated type rubber connector is manufactured by alternately laminating electric conductive rubbers obtained by mixing carbon black powder or metal particles into rubber and electric insulation rubbers and curing the laminated rubber, followed by cutting thereof. Furthermore, examples of the other proposed rubber connectors include a metal fiber rubber connector, a magnetic arrangement type rubber connector, and the like (see JP59 (1984)-52478B). The metal fiber rubber connector is obtained by mixing a metal fiber into a rubber or resin to form a mixed material and arranging/orienting the mixed electric conductive materials in the uniform direction by using an extruder, and the magnetic arrangement type rubber connector is obtained by mixing metal thin wires into liquid resin, followed by arranging the mixture in the magnetic field in the direction of thickness so that the magnetic metal thin wires are aligned in the thickness direction.

However, in the above-mentioned conventional metal fiber rubber connector, when metal fibers having a conductive function are arranged/oriented in the uniform direction, all the metal fibers are not exposed from the pressure welding face of the metal fiber rubber connector because of the limitation of the length of the metal fiber. Therefore, it is difficult to obtain the metal fiber connector with sufficient height (thickness), and it was difficult to adjust the pitch, for example, to make the pitch fine or rough, and also difficult to align the metal fibers at a constant pitch. Furthermore, in the magnetic arrangement type rubber connector, magnetic metal conductors mixed in liquid resin are aligned in the magnetic field, in which the magnetic metal conductors are aligned regularly and arranged with the magnetic field controlled. Therefore, the pitch or arrangement of the magnetic metal conductor cannot be adjusted precisely, so that it is difficult to obtain an anisotropic conductive rubber connector with precise and fine pitches. Furthermore, since the magnetic metal conductors are arranged in the magnetic field, it is necessary to remove magnetic metal conductors that cannot be arranged precisely because they do not react to the magnetic field.

### SUMMARY OF THE INVENTION

Therefore, with the foregoing in mind, it is an object of the present invention to provide an anisotropic conductive elastic connector that does not cause a short even if metal fibers are arranged with high density.

In order to achieve the above-mentioned object, the anisotropic conductive elastic connector of the present invention includes plural linear conductors arranged in the thickness direction of an insulation elastic resin material. On the side face of the linear conductor, an electric insulation coating having a withstand voltage of 1 V/μm or more is formed in a thickness of 1 μm or more. The linear conductors are arranged a with pitch interval of 0.01 mm or less or are adjacent to each other in the direction of the arrangement.

### BRIEF DESCRIPTION OF THE DRAWINGS

FIG. 1A is a perspective view showing an anisotropic conductive elastic connector according to one embodiment of the present invention.

FIG. 1B is an enlarged cross-sectional view showing a part shown by “a” in FIG. 1A.

FIG. 1C is a perspective view showing an anisotropic conductive elastic connector according to another embodiment.

FIG. 2A is a top plan view of an anisotropic conductive elastic connector showing an example of an arrangement density and an arrangement pattern of linear conductors of an anisotropic conductive elastic connector according to one embodiment of the present invention.

FIG. 2B is an enlarged cross-sectional view showing a part shown by “b” in FIG. 2A.

FIG. 2C is a top plan view showing an anisotropic conductive elastic connector according to another embodiment.

FIG. 2D is an enlarged cross-sectional view showing a part shown by “c” in FIG. 2C.

FIG. 2E is a top plan view showing an anisotropic conductive elastic connector according to a still further embodiment.

FIG. 2F is an enlarged cross-sectional view showing a part shown by “d” in FIG. 2E.

FIGS. 3A to 3C are cross-sectional views showing a manufacturing process for an anisotropic conductive elastic connector according to one embodiment of the present invention.

FIGS. 4A to 4B are perspective views showing a manufacturing process for an anisotropic conductive elastic connector according to one embodiment of the present invention.

### DETAILED DESCRIPTION OF THE INVENTION

In the anisotropic conductive elastic connector of the present invention, plural linear conductors are arranged in the thickness direction of an insulation elastic resin material. On the side face of the linear conductor, an electric insulation coating having a withstand voltage of 1 V/μm or more is formed to a thickness of 1 μm or more. The linear conductors are arranged with a pitch interval of 0.01 mm or less or are adjacent to each other in the direction of the arrangement.

In the present invention, the electric insulation coating may be obtained by applying a coating of, for example, a polyimide resin (polyamic acid) and subjecting it to a baking treatment; and applying a coating of a polyesterimide resin, a polyamide imide resin, or the like, and subjecting it to a baking treatment. The preferable thickness of the electric insulation coating is in the range from 3 μm to 10 μm.

It is preferable that the end of the linear conductor is exposed from the insulation elastic resin material and has a length that is substantially the same as the thickness of the insulation elastic resin material.

Furthermore, it is preferable that corrosion inhibiting plating is provided on the end face of the linear conductor. Herein, the corrosion inhibiting plating includes, for example, nickel plating, gold plating, solder plating, tin plating, silver plating, and the like, and coating with chemically stable material to the thickness of 0.01 μm to 3 μm. The gold plating is particularly preferable.

Furthermore, it is preferable that the arrangement density of the linear conductors is different depending on a predetermined conducting current capacity.

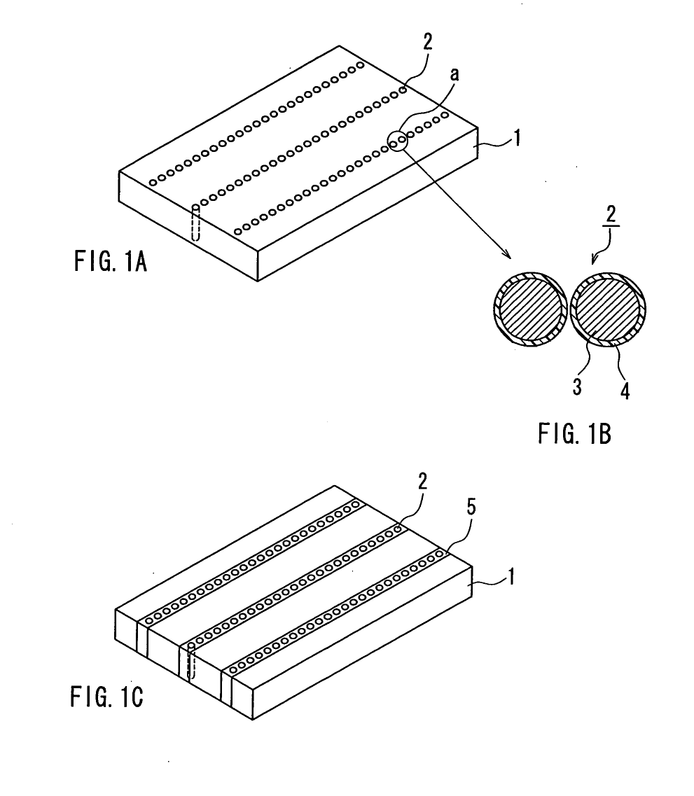

The following is explanation with reference to drawings. FIG. 1A is a perspective view showing an anisotropic conductive elastic connector of one embodiment of the present invention. As shown in FIG. 1A, in the thickness direction of the insulation elastic resin 1 such as silicone rubber, for example, a plurality of linear conductors 2 such as beryllium copper wires are arranged. FIG. 1B is an enlarged cross-sectional view showing a part shown by “a” in FIG. 1A. The linear conductor 2 is formed of a metal wire 3 and an electric insulation coating 4 having a withstand voltage of 1 V/μm or more formed to a thickness of 1 μm or more on the side face of the metal wire 3. The pitch interval between the linear conductors 2 in the direction of arrangement is 0.01 mm or less. FIG. 1C shows an example where a different insulation elastic resin 5 is used for only a part in which the linear conductors 2 are arranged.

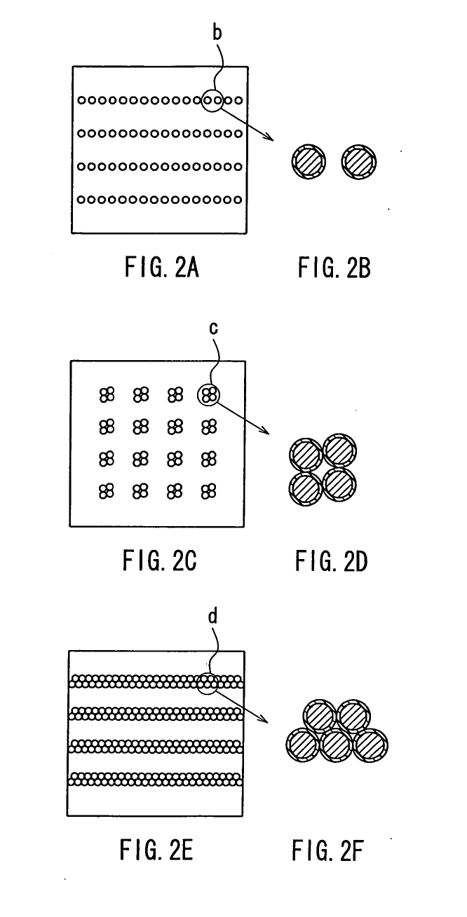

FIGS. 2A to 2F show examples of the arrangement density and the wiring pattern of the linear conductors. FIG. 2B is an enlarged cross-sectional view showing a part shown by “b” in FIG. 2A. FIG. 2D is an enlarged cross-sectional view showing a part shown by “c” in FIG. 2C. FIG. 2F is an enlarged cross-sectional view showing a part shown by “d” in FIG. 2E. First of all, FIG. 2A shows an example of a simple arrangement that is the same as in FIG. 1A where the linear conductors are arranged with a pitch interval therebetween, respectively. Next, FIG. 2C shows an example where the linear conductors are arranged in a way in which every four linear conductors are adjacent to each other. Next, FIG. 2E shows an example where two rows of the linear conductors are adjacent to each other and in each row, the linear conductors are closest packed.

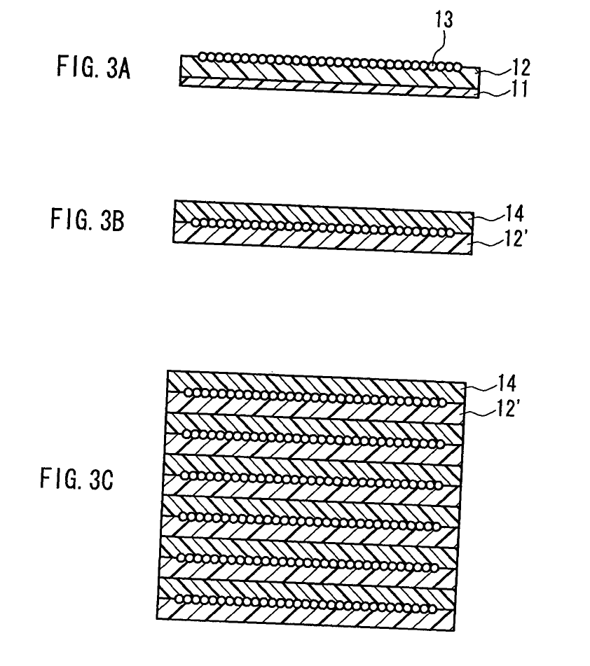

The anisotropic conductive elastic connector of the present invention can be manufactured by, for example, the following process. First of all, as shown in FIG. 3A, on a polyethylene terephthalate film 11, a thin unvulcanized rubber sheet 12 is formed, and linear conductors 13 are arranged thereon in parallel to and close contact with each other. The thin unvulcanized rubber sheet 12 is cured in this state so as to form a cured rubber sheet 12′.

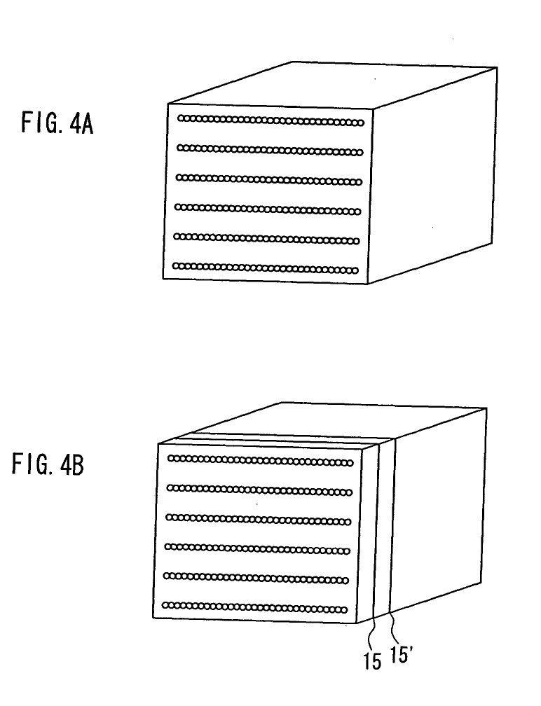

Next, on the linear conductors 13 arranged on the cured rubber sheet 12′, a thin unvulcanized rubber sheet 14 is further adhered thereon (see FIG. 3B). A plurality of the sheets adhered to each other are laminated so as to form a block form (see FIG. 3C). The block-formed laminated sheet is heated and vulcanized in this state, and cured (see FIG. 4A), followed by slicing to an arbitrary thickness (see FIG. 4B). Reference numerals 15 and 15′ show slice lines.

According to the present invention, it is possible to obtain anisotropic conductive elastic connectors having any height and it is possible to obtain a high density anisotropic conductive elastic connector in which linear conductors are arranged with an arrangement pitch interval of 0.01 mm or less or are adjacent to each other.

As mentioned above, the anisotropic conductive elastic connector of the present invention can include linear conductors with high density and is suitable for obtaining an electric connection between electric components and a circuit board.

The present invention will be explained more specifically by way of Examples.

### EXAMPLE 1

To 100 parts by weight of hot vulcanized silicone rubber (degree of hardness after cured: 50° (JIS K 6249)), “SH1185U” product of Dow Corning Toray Silicone Co., Ltd.: SH1185U), 1 part by weight of 2,4-dichlorobenzoyl peroxide as a vulcanizing agent was added and adjusted to form a silicone rubber mixture. The silicone rubber mixture was sandwiched between polyethylene terephthalate (PET) films having the thickness of 100 μm so as to form a preform sheet having a width of 100 mm, length of 600 mm and a thickness of 0.3 mm by a calendar roll.

Next, the PET film on one face of the preform sheet was peeled off and the PET film on another face was fixed to a reel drum of a reel device.

Next, a thin beryllium copper wire having a diameter φ of 0.03 mm and insulation-coated with polyesterimide resin having a thickness of 0.003 mm was attached to the reel device and then the thin beryllium copper wire was reeled up at a constant pitch onto the preform sheet on the face of the drum, with the rate of revolutions on the reel drum at 30 rpm and at the feeding rate of 1.23 mm/min.

After reeling was finished, the reel drum as a whole was heated at 120° C. for 30 minutes in a hot-air circulation oven so as to vulcanize and cure the preform sheet on the face of the drum. As a result, a vulcanized preform sheet in which the thin beryllium copper wire was integrated and fixed on the preform sheet was obtained.

In this way, two kinds of vulcanized preform sheets were obtained, in which 24 and 55 beryllium copper wires per 1 mm respectively were arranged in parallel on a silicone rubber layer formed on the 0.1 mm thick PET film.

Each preform sheet was removed from the reel drum and opened. Thus, an arrangement sheet on which beryllium copper wires were arranged on the silicone rubber was obtained.

On the face of the vulcanized arrangement sheet on which beryllium copper wires were arranged, the unvulcanized silicone mixture sheet having a width of 100 mm, length of 650 mm and thickness of 0.3 mm was adhered, followed by continuously cutting into pieces having a width of 100 mm and a length of 100 mm. 200 of the thus obtained sheets, which were laminated in a mold with the arrangement direction of the beryllium copper wires adjusted, were placed in the hot-air circulation type oven and heated to be cured at 180° C. for 8 hours, resulting in a block.

Next, the block was sliced perpendicular to the longitudinal direction of the beryllium copper wire to the thickness of 1.5 mm. Thereafter, in order to complete a polymerization reaction of the silicone rubber, the sliced product was further subjected to a secondary vulcanization in the hot-air circulation oven at 180° C. for 120 minutes so as to obtain a slice sheet.

Next, the slice sheet was cut into pieces having a width of 5 mm and length of 15 mm. To the cut face of the thin beryllium copper wires that are exposed by slicing the face of the slice sheet, 0.2 μm of electroless nickel plating was provided and 0.15 μm of gold plating was further provided thereon. Thus, an anisotropic conductive elastic connector was obtained.

The obtained connector had a width of 5 mm, length of 15 mm and thickness of 1.5 mm, and on the face thereof, the beryllium copper wires as a conductor penetrate in the direction of the thickness, and they were oriented in rows. The orienting density of the beryllium copper wires was 24 wires per 1 mm in the direction of the row. The distance of the space between the aligned conductors was 0.005 mm, and the distance between the rows was about 0.6 mm.

The cut faces of the beryllium copper wires exposed in the direction of the thickness were applied with nickel plating (0.2 μm) and gold plating (0.15 μm) by an electroless plating method. By the above-mentioned process, an anisotropic conductive elastic connector was obtained.

The obtained anisotropic conductive elastic connector had a width of 52 mm, length of 52 mm and thickness of 1.2 mm, and on the face thereof, the beryllium copper wires are exposed in the thickness direction and they are oriented in rows on the face thereof.

In the anisotropic conductive elastic connector obtained as mentioned above, the impact resilience at the time of pressure welding can be suppressed, so that the anisotropic conductive elastic connector was suitable for the electrical connection between electric/electronic components and a circuit board.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. An anisotropic conductive elastic connector, comprising plural linear conductors arranged in the thickness direction of an insulation elastic resin material;
wherein an electric insulation coating having a withstand voltage of 1 V/μm or more is formed to a thickness of 1 μm or more on a side face of the linear conductor; and
the linear conductors are arranged with a pitch interval of 0.01 mm or less or are adjacent to each other in the direction of the arrangement.

2. The anisotropic conductive elastic connector according to claim 1, wherein the end of the linear conductor is exposed from the insulation elastic resin material and has a length that is substantially the same as the thickness of the insulation elastic resin material.

3. The anisotropic conductive elastic connector according to claim 1, wherein corrosion inhibiting plating is provided on an end face of the linear conductor.

4. The anisotropic conductive elastic connector according to claim 3, wherein the corrosion inhibiting plating is electroless plating.

5. The anisotropic conductive elastic connector according to claim 4, wherein the electroless plating is provided by providing gold plating on nickel plating.

6. The anisotropic conductive elastic connector according to claim 1, wherein the arrangement density of the linear conductors is different depending on a predetermined conducting current capacity.

7. The anisotropic conductive elastic connector according to claim 1, wherein the insulation elastic resin is a silicone rubber.

8. The anisotropic conductive elastic connector according to claim 1, wherein the linear conductor is a copper wire or a beryllium copper wire.

9. The anisotropic conductive elastic connector according to claim 1, wherein at least one end of the linear conductor is sliced together with the insulation elastic resin.
